(19) United States
(12) Patent Application Publication
(10) Pub. No.: US 2026/0054590 A1
(43) Pub. Date: Feb. 26, 2026

(54) CHARGING CONTROL METHOD FOR USING VEHICLE TO LOAD (V2L) FUNCTION

(71) Applicants: Hyundai Motor Company, Seoul (KR); Kia Corporation, Seoul (KR)

(72) Inventors: Jin-Su Jang, Hwaseong-si (KR); Bum-Jin Kim, Hwaseong-si (KR); Yeong-Ju Kang, Hwaseong-si (KR); Moon-Kyung Joo, Hwaseong-si (KR); Jong-Hyeok Park, Hwaseong-si (KR)

(21) Appl. No.: 19/226,713

(22) Filed: Jun. 3, 2025

(30) Foreign Application Priority Data
Aug. 26, 2024 (KR) 10-2024-0114179

(51) Int. Cl. B60L 53/62; B60L 1/00

(52) U.S. Cl. CPC B60L 53/62; B60L 1/00; B60L 2210/40

(57) ABSTRACT

In an embodiment a charging control method includes determining, by a charging controller, whether an electric coupling of a vehicle unit of a vehicle to a ground unit of a ground equipment is completed, checking, by the charging controller, whether DC charging or AC charging is performed based on a completion of the electric coupling and controlling, by the charging controller, an on-board charger for the AC charging or a junction box for the DC charging to provide a V2L discharge functionality based on a check.

### CROSS-REFERENCE TO RELATED APPLICATIONS

This application claims priority to Korean Patent Application No. 10-2024-0114179, filed on Aug. 26, 2024, which is incorporated herein by reference in its entirety.

### TECHNICAL FIELD

The present disclosure relates to a charging control technology, and more specifically, to a charging control method capable of using a vehicle to load (V2L) function in real time while charging an electric vehicle.

### BACKGROUND

A vehicle to load (V2L) function of current electric vehicles has an advantage that electric energy of the vehicle can be used anytime, anywhere. Accordingly, even outdoors, anyone can easily connect a V2L connector to a charging port of a vehicle and use electric loads such as home appliances or tools as long as the vehicle supports the V2L function.

However, when the V2L function is used excessively, a state of charge of a high-voltage battery becomes insufficient, leading great restriction on vehicle movement. It has a problem of causing inconvenience and anxiety to users.

For example, when a user moves to an outdoor campsite far from home and then the state of charge of the high-voltage battery becomes insufficient due to excessive use of the V2L function, the user can have great difficulty returning home.

### SUMMARY

Various embodiments of the present disclosure have been proposed to solve the above problems and are directed to providing a charging control method of charging a vehicle while using a vehicle to load (V2L) function.

In addition, various embodiments of the present disclosure are directed to providing a charging control method capable of resolving inconvenience and anxiety to the use of a V2L function.

To achieve these embodiments, the present disclosure provides a charging control method of charging a vehicle while using a V2L function.

The charging control method includes determining, by a charging controller, whether docking (also referred to as electrically coupling or connecting) between a ground unit and a vehicle unit of an automatic charging device is completed, checking, by the charging controller, whether it is DC charging or AC charging when the docking is completed, and controlling, by the charging controller, an on-board charger for the AC charging or a junction box for the DC charging to use the V2L function depending on whether it is the DC charging or AC charging as the result of the check.

In addition, the controlling includes operating, by the charging controller, the on-board charger in a charging mode in which a battery is charged and operating the junction box in an OFF state in the case of the AC charging.

In addition, AC power supplied through the vehicle unit is supplied to both the on-board charger present on an AC charging current path and a manual charging unit present on a V2L discharging current path.

In addition, the OFF state blocks electrical connection between the manual charging unit and the battery and between the vehicle unit and the battery.

In addition, the controlling includes operating, by the charging controller, the on-board charger in a discharging mode and operating the junction box in an ON state in the case of the DC charging.

In addition, DC power supplied through the vehicle unit is supplied to only the junction box present on a DC charging current path.

In addition, the charging controller converts DC power from the battery into AC power using the on-board charger and supplies the converted AC power to the manual charging unit present on a V2L discharging current path.

In addition, the ON state electrically connects the vehicle unit to the battery.

In addition, the charging controller maintains the junction box in an OFF state at all times upon non-charging.

In addition, the controlling includes determining, by the charging controller, whether the AC charging or the DC charging is completed, and releasing, by the charging controller, the docking between the ground unit and the vehicle unit when the AC charging or the DC charging is completed.

In addition, the ground unit is a separate type in which it is connected to an off-board charger through a cable or an integrated embedded type in which it is integrated with the off-board charger and embedded in the ground.

In addition, the determining of whether the AC charging or the DC charging is completed includes determining, by the charging controller, that the docking is successful or failed based on a preset number of times docking retry.

According to the present disclosure, the user can use the V2L function in real time while charging.

In addition, according to the present disclosure, it is possible to improve user charging convenience and/or vehicle productivity.

In addition, according to the present disclosure, it is possible to provide a new user experience (UX)/user interface (UI) to the user when an embedded ground unit (GU) integrated with the charger is installed at the outdoor campsite.

### BRIEF DESCRIPTION OF THE DRAWINGS

FIG. 1 is a block diagram of a configuration of an electric vehicle charging system according to an exemplary embodiment of the present disclosure;

FIG. 2 is a block diagram of a configuration of a vehicle charging apparatus configured in an electric vehicle illustrated in FIG. 1;

FIG. 3 is a view illustrating an operation concept upon AC charging using an automatic charging device (ACD) in the vehicle according to an exemplary of the present disclosure;

FIG. 4 is a view illustrating an operation concept upon DC charging using the ACD in the vehicle according to an exemplary of the present disclosure;

FIGS. 5 and 6 are flowcharts illustrating a charging control method for using a vehicle to load (V2L) function according to an exemplary of the present disclosure; and

FIG. 7 is an operational flowchart illustrating a charging communication sequence between an off-board charger, a ground unit, a vehicle unit, and a charging controller according to an exemplary embodiment of the present disclosure.

### DETAILED DESCRIPTION OF ILLUSTRATIVE EMBODIMENTS

The above-described objects, features, and advantages will be described below in detail with reference to the accompanying drawings, and thus those skilled in the art to which the present disclosure pertains will be able to easily carry out the technical spirit of the present disclosure. In describing the present disclosure, when it is determined that a detailed description of the known technology related to the present disclosure may unnecessarily obscure the gist of the present disclosure, a detailed description thereof will be omitted.

Hereinafter, exemplary embodiments according to the present disclosure will be described in detail with reference to the accompanying drawings. In the drawings, the same reference numerals are used to denote the same or similar components.

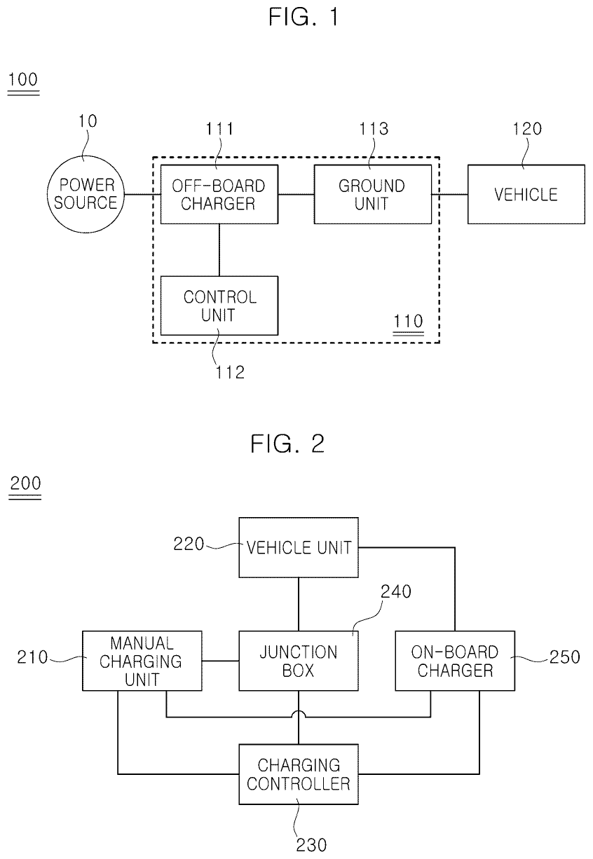

FIG. 1 is a block diagram of a configuration of an electric vehicle charging system 100 according to an exemplary embodiment of the present disclosure. Referring to FIG. 1, the electric vehicle charging system 100 may include charging equipment 110 for receiving power from a power source 10 and providing charging power, a vehicle 120 for receiving the charging power from the charging equipment 110, and the like. In this case, the power source 10 may be an AC grid, and the vehicle 120 may be an electric vehicle. The power source 10 supplies 110 V or 220 V.

The charging equipment 110 may be electric vehicle charging equipment (EVSE). Accordingly, the charging equipment 110 may include an off-board charger 111, a controller 112, and the like. In this case, the charging equipment 110 may include a ground unit (GU) 113 for supporting an automatic connection method. In particular, the automatic connection method may be an automatic charging device-underbody (ACD-U).

The ground unit 113 is a separate type which is configured separately from the off-board charger 111 and connected by a cable. Of course, the ground unit 113 may be an integrated embedded type which is integrated with the off-board charger 111 and embedded in the ground.

The off-board charger 111 may serve to receive AC power from the power source 10, convert the AC power into charging power, and supply the charging power to a vehicle. The off-board charger 111 may be a bidirectional charger. To this end, a rectifier, a DC power supply, and the like may be configured.

The controller 112 may serve to control the off-board charger 111. To this end, the controller 112 may include a microprocessor, a microcomputer, a communication circuit, a memory, a display, and an input means. The display may be a touch screen or the like. Therefore, both an input means and an output means are possible. Of course, the input means may be a button, a microphone, or the like.

The ground unit 113 may be docked/electrically coupled to a vehicle unit (VU) (not illustrated) mounted at the bottom of the vehicle 120 when performing charging using the automatic connection method.

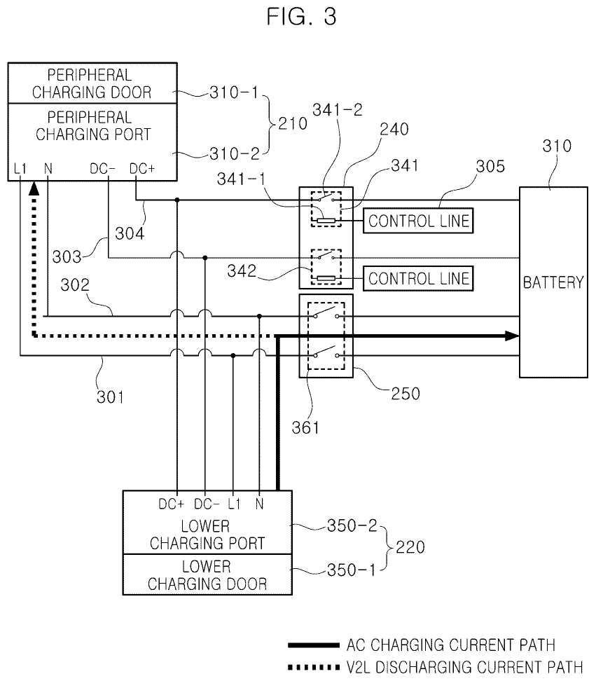

FIG. 2 is a block diagram of a configuration of a vehicle charging apparatus 200 configured in the electric vehicle 120 illustrated in FIG. 1. Referring to FIG. 2, the vehicle charging apparatus 200 may include a manual charging unit 210, a vehicle unit 220, a charging controller 230, a junction box 240, an on-board charger 250, and the like.

The manual charging unit 210 may be connected to a charging connector of the charging equipment 110 to transmit charging power and/or control signals. The manual charging unit 210 may be composed of a combined charging system 1 (CCS 1) type charging port, a CCS2 type charging port, and/or a North American charging standard (NACS) type charging port. Of course, the manual charging unit 210 may have a different shape depending on a slow charging method and a fast charging method.

The manual charging unit 210 may have several terminals (not illustrated) fastened to several pins (not illustrated) formed on the charging connector of the charging equipment 110. Of course, the pins and the terminals may be formed differently depending on the CCS1 type, the CCS2 type, or the NACS type.

Although not explicitly illustrated in FIG. 2, a detection block (not illustrated) which serves to detect whether the charging connector (not illustrated) is correctly connected to the manual charging unit 210 and generate a detection signal may be provided. That is, when the charging connector is not properly connected to the manual charging unit 210, the detection block may serve to detect this and transmit the detection signal to the charging controller 230.

In this case, the detection block may be implemented by a method of using a distance difference between the charging connector and the manual charging unit 210 using a proximity sensor, an infrared sensor, and the like. Alternatively, the detection block may be implemented by a method of detecting a current voltage, which flows minutely as the charging connector and the manual charging unit 210 are connected, using a current sensor, a voltage sensor, and the like.

The vehicle unit 220 may be a unit installed on a vehicle to charge a battery of the vehicle using the ACD and mounted at the bottom of the vehicle to serve as conventional manual charging ports (side/front inlets). In this case, the vehicle unit 220 may be connected by being docked/electrically coupled to the ground unit 113 installed on the charging equipment. When the ground unit 113 configured on the automatic charging equipment 110 is connected to the vehicle unit 220 configured on the vehicle 120, charging power and/or control signals may be transmitted between the charging equipment 110 and the vehicle 120.

Accordingly, the ground unit 113 and the vehicle unit 220 are components of the ACD, and as the ACD, an ACD-U may be used.

The charging controller 230 may perform charging control by at least one of DC charging and AC charging.

In this case, the charging controller 230 may determine one of the DC charging and the AC charging using signals received through a control pilot (CP), proximity detection (PD), and/or a ground (GND) line. For example, the charging controller 230 may select one of the DC charging and the AC charging using a CP duty.

In this case, the charging controller 230 may perform charging control using the CCS1 type, the CCS2 type, or the NACS type according to the detection signal. That is, the charging controller 230 may control the junction box 240 and/or the on-board charger 250 depending on whether the manual charging unit 210 is the CCS 1 type, the CCS 2 type, or the NACS type.

To this end, the charging controller 230 may include a microcomputer, a microprocessor, an electronic circuit, a communication circuit, a memory, or the like. In addition, the charging controller 230 may include a vehicle controller (not illustrated), which is an upper level controller, or may be communicatively connected to the vehicle controller to transmit and receive data.

The memory may be configured in combination of non-volatile memories, such as a solid state disk (SSD), a hard disk drive, a flash memory, an electrically erasable programmable read-only memory (EEPROM), a static RAM (SRAM), a ferro-electric RAM (FRAM), a phase-change RAM (PRAM), and a magnetic RAM (MRAM) and/or volatile memories, such as a DRAM, a synchronous DRAM (SDRAM), and a double data rate-SDRAM (DDR-SDRAM).

The junction box 240 may supply DC power to a battery (not illustrated) or block the supply of the DC power to the battery.

The on-board charger 250 is installed in the vehicle 120 to receive AC power and convert the AC power into DC power for charging. Generally, charging of electric vehicles is classified into slow charging and fast charging. The slow charging is a method of converting AC power into DC power for charging to charging a battery.

In contrast, the fast charging is a method of charging a battery directly using a high DC voltage without the on-board charger 250.

Of course, the on-board charger 250 may be a bidirectional charger. Accordingly, the on-board charger 250 may be operated in a charging or discharging mode. To this end, the on-board charger 250 may include a power factor correction (PFC), an AC-DC converter, a rectifier, and the like.

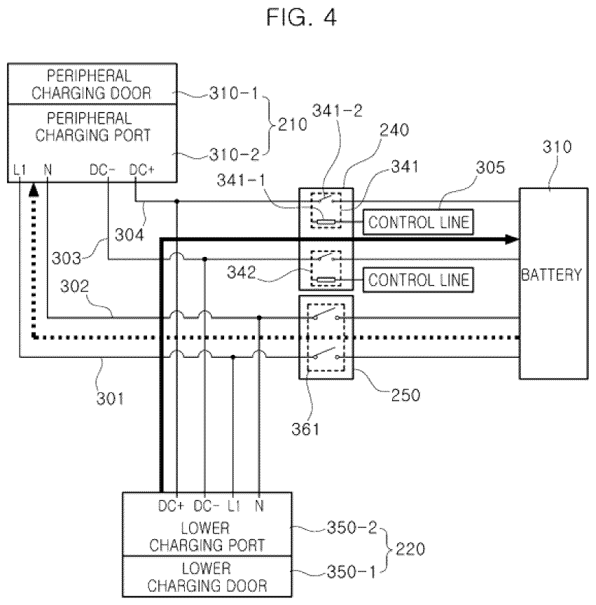

FIG. 3 is a view illustrating an operation concept upon AC charging using the ACDs 113 and 220 in the vehicle according to an exemplary embodiment of the present disclosure. Referring to FIG. 3, AC power lines 301 and 302 include an Li line 301 and an N line 302 for AC power, and DC power lines 303 and 304 include a DC-line 303 and a DC+ line 304.

Of course, although not explicitly illustrated in FIG. 3, a CP line, a PD line, and a PE (i.e., GND) line are present and are connected to the charging controller 230 through the manual charging unit 210 and the vehicle unit 220.

The manual charging unit 210 includes a peripheral charging door 310-1 and a peripheral charging port 310-2, and the peripheral charging door 310-1 is used to open or close the peripheral charging port 310-2 in an opened and closed manner. Of course, when a contact sensor (not illustrated) may be installed on the peripheral charging door 310-1 and opened or closed, an opened state or closed state may be transmitted to the charging controller 230.

The peripheral charging door 310-1 and the peripheral charging port 310-2 may be formed on front, rear, side surfaces, and the like of the vehicle. A charging connector (not illustrated) is connected to the charging port 310-2.

Types generally applied to the charging connector and the charging port are as illustrated in the following table.

TABLE 1

| | |
|---|---|
| L1 | AC Power |
| L2/N | AC Power |
| CP | Control Pilot |
| PD | Proximity Detection |
| PE | Ground |
| DC+ | Power supply (+) |
| DC− | Power supply (−) |

Referring to FIG. 3, the vehicle unit 220 includes a lower charging door 350-1 and a lower charging port 350-2 and the lower charging door 350-1 is used to open or close the lower charging port 350-2 in an opened and closed manner.

The junction box 240 is disposed between the manual charging unit 210/vehicle unit 220 and a battery 310 to supply DC power to the battery 310 or blocking the supply of the DC power. To this end, the junction box 240 has first and second junction switching elements 341 and 342 formed parallel to each other.

That is, the first junction switching element 341 is connected to the DC+ line 304, and the second junction switching element 342 is connected to the DC-line 303. The first and second junction switching elements 341 and 342 are mainly used as power relays. Accordingly, the first and second junction switching elements 341 and 342 include a contact part 341-1 and a coil 341-1 formed to operate the contact portion 341-1.

Of course, as the first and second junction switching elements 341 and 342, semiconductor switching elements such as a field effect transistor (FET), a metal oxide semiconductor FET (MOSFET), an insulated gate bipolar mode transistor (IGBT), and a power rectifier diode, a thyristor, a gate turn-off (GTO) thyristor, and a triode for alternating current (TRIAC), a silicon controlled rectifier (SCR), an IC circuit, or the like may be used.

In particular, as the semiconductor element, bipolar or power MOSFET elements, or the like may be used. The power MOSFET elements operate at high voltage and high current and unlike general MOSFETs, have a double-diffused metal oxide semiconductor (DMOS) structure.

The first and second junction switching elements 341 and 342 are connected to the charging controller 230 through a control line 305. Accordingly, the first and second junction switching elements 341 and 342 perform an on operation or an off operation according to the on/off signal of the charging controller 230.

Referring to FIG. 3, the on-board charger 250 is disposed between the manual charging unit 210/vehicle unit 220 and the battery 310 to convert AC power into DC power and supply the DC power to the battery 310 or block the supply of the DC power. To this end, an on/off switching element 361 may be configured at an input terminal and/or output terminal of the on-board charger 250. Accordingly, the on/off switching element 361 serves to conduct or block AC power or DC power through the operation of the on/off switching element 361.

Accordingly, when AC charging is executed using the ACD, the on-board charger 250 operates only in a charging mode for charging the battery 310 and is not involved in the use of the V2L function. That is, the AC power supplied through the ACD is supplied to both the peripheral charging port 310-1 present on a V2L discharging current path and the on-board charger 250 on an AC charging current path.

Accordingly, AC power may be supplied to home appliances through a V2L connector (not illustrated) connected to the peripheral charging port 310-1. Of course, the junction box 240 is operated in an OFF state at this time. Such an OFF state blocks electrical connection between the manual charging unit 210 and the battery 310 and between the vehicle unit 220 and the battery 310.

The battery 310 includes battery cells (not shown) configured in series and/or parallel, and the battery cells may be high-voltage battery cells for electric vehicles, such as nickel metal battery cells, lithium ion battery cells, lithium polymer battery cells, lithium sulfur battery cells, sodium sulfur battery cells, and all-solid-state battery cells. In general, a high-voltage battery indicates a battery used as a power source for moving electric vehicles and has a high voltage of 100 V or more. However, the present disclosure is not limited thereto, and low-voltage batteries are also possible.

Of course, the battery 310 may include a battery management system (BMS). The BMS serves to increase energy efficiency and extend lifetime by optimizing management of an electric vehicle battery. It is possible to increase the stability and reliability of the battery by monitoring a voltage, current, and temperature of the battery in real time and preventing excessive charging and discharging.

In FIG. 3, the charging and the V2L function have been described when the ACD is applied to the vehicle using the CCS1 type, but it may be similarly applied to a vehicle using the CCS2 type and a vehicle using the NACS type.

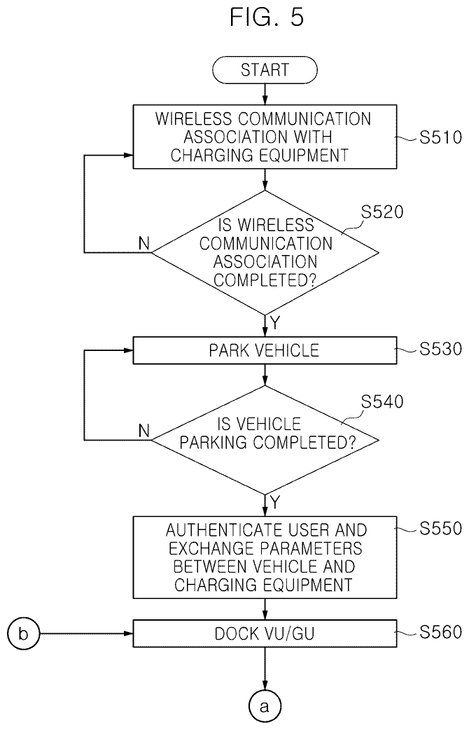

FIG. 4 is a view illustrating an operation concept upon DC charging using the ACDs 113 and 220 in the vehicle 120 according to one embodiment of the present disclosure. Referring to FIG. 4, when the V2L function is used during DC charging using the ACD, the on-board charger 250 operates in a discharging mode to use the V2L function. That is, the on-board charger 250 converts DC power from the battery 310 into AC power and discharges the AC power to support the V2L function. Of course, the junction box 240 maintains an ON state at this time. In this case, the junction box 240 electrically connects the vehicle unit 220 to the battery 310.

The DC power supplied through the vehicle unit 220 is supplied only to the junction box 240 present on the DC charging current path. Of course, the DC power from the battery 310 is converted into AC power using the on-board charger 250, and the AC power is supplied to the manual charging unit 210 present on the V2L discharging current path.

For understanding, operation conditions of the on-board charger 250 and the junction box 240 according to FIGS. 3 and 4 are simply summarized as follows.

TABLE 2

| | | |
|---|---|---|
| Component | AC charging | DC charging |
| On-board charger | Charging | Discharging |
| Junction box | OFF | ON |

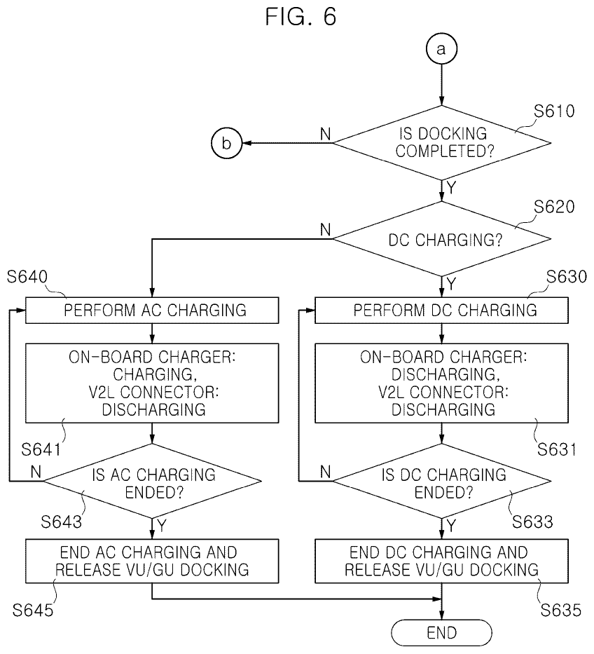

FIGS. 5 and 6 are flowcharts illustrating a charging control method for using a V2L function according to an exemplary embodiment of the present disclosure. Referring to FIG. 5, wireless communication connection is attempted between the charging equipment 110 and the vehicle 120 (operation S510). That is, wireless communication with the charging equipment 110 is attempted using a communication program installed in the vehicle. The communication program may be an app installed in the vehicle or an app installed on a terminal of a driver.

Thereafter, the driver checks whether the wireless communication connection is completed (operation S520).

When the wireless communication connection is not completed in operation S520, the vehicle 120 re-attempts wireless communication connection and re-performs operations S510 and S520.

In contrast, as the result of the check, when the wireless communication connection is completed in operation S520, the vehicle 120 is moved and parked (operation S530). That is, the vehicle 120 is moved and parked so that the ground unit 113 and the vehicle unit 220, which are ACDs, may enter a dockable range. Of course, the parking may be manned or unmanned.

Thereafter, the vehicle 120 checks whether the vehicle parking is completed (operation S540). That is, it is possible to determine whether the vehicle parking is completed considering a position (e.g., a P gear) of a vehicle gear and an ignition state (e.g., an ignition off).

As the result of the check, when the vehicle parking is not completed in operation S540, operations S530 and S540 are re-performed.

In contrast, as the result of the check, when the vehicle parking is completed in operation S540, user authentication is performed and parameter exchange is performed between the vehicle 120 and the charging equipment 110 (operation S550). As the user authentication, authentication such as a plug and charge (PnC) method may be used. Accordingly, charging and billing may be performed automatically without user intervention.

Through such parameter exchange, it is possible to check whether the off-board charger 111 of the charging equipment 110 is an AC charger or a DC charger. The parameters may include a maximum charging power/voltage/current, a current state of charge (SoC), a target SOC, and a departure time.

Thereafter, docking of the vehicle unit 220 and the ground unit 113 is performed (operation S560). That is, the vehicle unit and the ground unit constituting the ACD may be automatically docked/electrically coupled.

Referring to FIG. 6, the charging controller 230 checks whether docking between the vehicle unit 220 and the ground unit 113 is completed (operation S610). To check the completion of docking, a contact sensor (not illustrated) may be configured on the vehicle unit (VU), and the contact sensor is connected to the charging controller 230.

As the result of the determination, when the docking is not completed in operation S610, operations S560 to S610 are re-performed.

In contrast, as the result of the determination, when the docking is completed in operation S610, the charging controller 230 checks whether it is DC charging or AC charging (operation S620). Meanwhile, the docking may be performed based on the number of times docking retry which is preset in operation S610, and when the number of times docking retry is not exceeded, it may be determined that the docking is successful. Of course, when the number of times docking retry is exceeded, it may be determined that the docking is failed. In this case, the procedure may be finished after the failure is finally processed.

As the result of the determination in operation S620, when it is DC charging, the DC charging is performed. At this time, the on-board charger 250 operates in a discharging mode and the V2L function also operates (operations S630 and S631). That is, the discharging mode is operated through the V2L connector. That is, the on-board charger 250 operates only in the discharging mode, and the junction box 240 operates in an ON (i.e., a closed) state.

Thereafter, the charging controller 230 checks whether the DC charging is completed (i.e., completion of the DC charging) (operation S633).

As the result of the check, when the DC charging is not completed in operation S633, operations S630 to S633 are performed.

In contrast, when the DC charging is completed in operation S633, the charging controller 230 finishes the DC charging, and the docking between the vehicle unit 220 and the ground unit 113 is released (operation S635).

Meanwhile, in operation S620, as the result of the check, when it is AC charging rather than DC charging, the AC charging is performed. At this time, the on-board charger 250 operates only in a charging mode and the V2L function also operates (operations S640 and S641). That is, the charging mode is operated through the V2L connector. That is, the on-board charger 250 operates only in the charging mode, and the junction box 240 operates in an OFF (i.e., an opened) state.

Thereafter, the charging controller 230 checks whether the AC charging is completed (i.e., completion of the AC charging) (operation S643).

As the result of the check, when the AC charging is not completed in operation S643, operations S640 to S643 are performed.

In contrast, when the AC charging is completed in operation S643, the charging controller 230 finishes the AC charging, and the docking between the vehicle unit 220 and the ground unit 113 is released (operation S645).

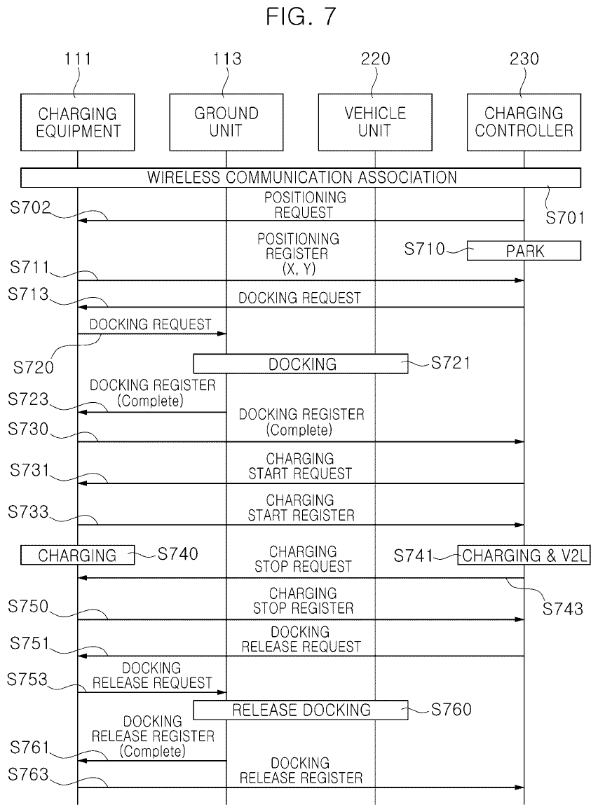

FIG. 7 is an operational flowchart illustrating a charging communication sequence between the charging equipment 110, the ground unit 113, the vehicle unit 220, and the charging controller 230 according to an exemplary embodiment of the present disclosure. Referring to FIG. 7, first, wireless communication association is performed (operation S701). As wireless communication, Wi-Fi is mainly used, but it is not limited thereto, and infrared data (IrDA) communication, a wireless LAN, ZigBee, Bluetooth, light fidelity (LiFi), near field communication (NFC), or the like may be used.

In this case, the wireless communication association may be performed between the charging equipment 110 and the charging controller 230, and at least one of the ground unit 113 and the vehicle unit 220 may participate. In this case, the charging controller 230 may be a concept including a vehicle controller, which is an upper level controller for controlling the entire charging controller 230 or may be a concept which is communicatively connected to the vehicle controller. The charging equipment 110 may be charging equipment of the ACD-U type automatic connection method. In FIG. 7, for the convenience of understanding, the ground unit 113 is described separately from the charging equipment 110.

The charging controller 230 transmits a positioning request to the charging equipment 110 (operation S702) and performs parking (operation S710).

The charging equipment 110 which has received the positioning request provides the positioning result to the vehicle (operation S711).

The charging controller 230 determines whether parking has ended in a dockable state based on the positioning result, and when it is determined that docking is possible, the charging controller 230 transmits a docking request to the charging equipment 110 (operation S713).

The charging equipment 110 which has received the docking request transmits the docking request to the ground unit 113 (operation S720).

The ground unit 113 which has received the docking request performs docking with the vehicle unit 220 (operation S721).

When docking is completed (i.e., based on completion of the docking), the ground unit 113 transmits a docking completion response (i.e., a docking register) to the charging equipment 110 (operation S723), and the charging equipment 110 which has received the docking completion response transmits the docking completion response (i.e., a docking register) to the charging controller 230 (operation S730).

The charging controller 230 which has received the docking completion response transmits a charging start request to the charging equipment 110 (operation S731), and the charging equipment 110 which has received the charging start request transmits the charging start response (i.e., a charging start register) to the charging controller 230 (operation S733).

The charging controller 230 and the charging equipment 110 which have received the charging start response perform charging (operations S740 and S741).

When charging is completed, the charging controller 230 transmits a charging end request to the charging equipment 110 (operation S743), and the charging equipment 110 which has received the charging end request transmits a charging stop response (i.e., a charging stop register) to the charging controller 230 (operation S750).

The charging controller 230 which has received the charging end response transmits a docking release request to the charging equipment 110 (operation S751), and the charging equipment 110 which has received the docking release request transmits a docking release request to the ground unit 113 (operation S753).

The ground unit 113 which has received the docking release request releases the docking with the vehicle unit 220 (operation S760).

When the docking is released, the ground unit 113 transmits a docking release completion response (i.e., a docking release register) to the charging equipment 110 (operation S761), and the ground unit 113 which has received the docking release completion response transmits the docking release completion response to the charging controller 230 (operation S763).

In addition, the operations of the method or algorithm described in relation to the embodiments disclosed herein may be implemented in the form of program commands that may be executed through various computer devices such as a microprocessor, a processor, and a CPU and stored in a computer-readable medium. The computer-readable medium may include program (command) codes, data files, data structures, etc. alone or in combination.

What is claimed is:

1. A charging control method comprising:
determining, by a charging controller, whether an electric coupling of a vehicle unit of a vehicle to a ground unit of a ground equipment is completed;
checking, by the charging controller, whether DC charging or AC charging is performed based on a completion of the electric coupling; and
controlling, by the charging controller, an on-board charger for the AC charging or a junction box for the DC charging to provide a V2L discharge functionality based on a check.

2. The charging control method of claim 1, wherein controlling includes operating, by the charging controller, the on-board charger in a charging mode for charging a battery of the vehicle and operating the junction box in an OFF state based on the AC charging.

3. The charging control method of claim 2, wherein AC power received at the vehicle unit is supplied to the battery via the on-board charger and a manual charging unit to provide the V2L discharge functionality.

4. The charging control method of claim 3, wherein the OFF state blocks electrical connection between the manual charging unit and the battery and between the vehicle unit and the battery.

5. The charging control method of claim 2, wherein controlling includes operating, by the charging controller, the on-board charger in a discharging mode and operating the junction box in an ON state based on the DC charging.

6. The charging control method of claim 5, wherein DC power received at the vehicle unit is only supplied to the junction box.

7. The charging control method of claim 5, wherein the charging controller converts DC power from the battery into AC power using the on-board charger and supplies the converted AC power to a manual charging unit to provide the V2L discharge functionality.

8. The charging control method of claim 5, wherein the ON state electrically connects the vehicle unit to the battery.

9. The charging control method of claim 1, wherein the charging controller maintains the junction box in an OFF state at all times based upon a non-charging mode.

10. The charging control method of claim 1, wherein controlling comprises:
determining, by the charging controller, whether the AC charging or the DC charging is completed; and
releasing, by the charging controller, the electric coupling based on a completion of the AC charging or the DC charging.

11. The charging control method of claim 1, wherein the determining of whether the AC charging or the DC charging is completed includes determining, by the charging controller, that the electric coupling is successful or failed based on a preset number of coupling retry times.

12. A charging control method for a vehicle comprising:
determining, by a charging controller of the vehicle, whether an electric coupling of a vehicle unit of the vehicle to a ground unit of a charging equipment is completed;
checking, by the charging controller, whether DC charging or AC charging is performed based on a completion of the electric coupling;
when the AC charging is performed:
operating an on-board charger of the vehicle in a charging mode to charge a battery of the vehicle;
maintaining a junction box in an OFF state to block electrical connection between a manual charging unit and the battery; and
supplying AC power received through the vehicle unit to both the on-board charger and the manual charging unit to enable a vehicle-to-load (V2L) functionality; and
when DC charging is provided:
operating the on-board charger in a discharging mode;
routing DC power received through the vehicle unit to the junction box for charging the battery base on the junction box being in an ON state; and
converting, by the on-board charger, DC power from the battery into AC power and supplying the converted AC power to the manual charging unit to enable the V2L functionality.

13. The charge control method of claim 12, further comprising:
determining, by the charging controller, when charging is completed; and
releasing the electric coupling when charging is completed.

14. The charge control method of claim 12, wherein the vehicle unit is mounted at an underbody of the vehicle.

15. The charge control method of claim 12, wherein the vehicle unit comprises:
a lower charging door configured to:
move between an open position and a closed position, and
receive control signals from a charging controller to automatically open based on the electric coupling with the ground unit; and
a lower charging port protected by the lower charging door.

16. The charge control method of claim 15, wherein the lower charging port comprises:
a plurality of electrical terminals configured to establish electrical connection with corresponding terminals of the ground unit,
at least one power terminal for receiving charging power from the ground unit,
at least one communication terminal for exchanging control signals with a charging equipment, and
at least one ground terminal.

17. The charging control method of claim 12, wherein the charging controller keeps the junction box in the OFF state at all times based on a non-charging mode.

18. The charging control method of claim 12, wherein the OFF state blocks electrical connection between the manual charging unit and the battery and between the vehicle unit and the battery.

19. The charging control method of claim 15, wherein DC power received at the vehicle unit is only supplied to the junction box.

20. A charging controller comprising:
a controller configured for:
determining whether an electric coupling of a vehicle unit of a vehicle to a ground unit of a ground equipment is completed;
checking whether DC charging or AC charging is performed based on a completion of the electric coupling; and
controlling an on-board charger for the AC charging or a junction box for the DC charging to provide a V2L discharge functionality based on a check.
